(19) United States
(12) Patent Application Publication
(10) Pub. No.: US 2017/0156049 A1
(43) Pub. Date: Jun. 1, 2017

(54) MANAGEMENT OF A SET OF IDENTIFIERS

(71) Applicant: Telefonaktiebolaget LM Ericsson (Publ), Stockholm (SE)

(72) Inventors: Mattias BERGSTRÖM, Stockholm (SE); Torsten DUDDA, Aachen (DE); Helka-Liina MÄÄTTANEN, Helsinki (FI)

(21) Appl. No.: 15/122,588

(22) PCT Filed: Jun. 29, 2016
(86) PCT No.: PCT/SE2016/050656

§ 371 Date: Aug. 30, 2016

Related U.S. Application Data
(60) Provisional application No. 62/193,805, filed on Jul. 17, 2015.

(51) Int. Cl. H04W 8/08; H04W 28/02; H04W 48/18

(52) U.S. Cl. CPC H04W 8/08; H04W 48/18; H04W 28/0226

(57) ABSTRACT

A method of operating a terminal device, the terminal device being capable of access network selection, traffic steering and/or traffic aggregation through a network node in a first network operating according to a first radio access technology, RAT, and a network node operating according to a second RAT, the method comprising storing a set of identifiers of network nodes operating according to the second RAT that can be used for access network selection, traffic steering and/or traffic aggregation; receiving an update signal, the update signal indicating one or more identifiers of network nodes operating according to the second RAT that are to be added to and/or removed from the stored set of identifiers; updating the stored set of identifiers based on the update signal; and performing an action using the updated set of identifiers.

### TECHNICAL FIELD

This disclosure relates to the management of a set of identifiers of network nodes that is stored in a terminal device, and in particular relates to the management of a set of identifiers of network nodes that can be used by the terminal device for access network selection, traffic steering and/or traffic aggregation.

### BACKGROUND

The wireless local-area network (WLAN) technology known as “Wi-Fi” has been standardized by IEEE in the 802.11 series of specifications (i.e., as “IEEE Standard for Information technology—Telecommunications and information exchange between systems. Local and metropolitan area networks—Specific requirements. Part 11: Wireless LAN Medium Access Control (MAC) and Physical Layer (PHY) Specifications”).

The IEEE 802.11 specifications regulate the functions and operations of the Wi-Fi access points (APs) or wireless terminals, collectively known as “stations” or “STA,” in the IEEE 802.11, including the physical layer protocols, Medium Access Control (MAC) layer protocols, and other aspects needed to secure compatibility and inter-operability between access points and portable terminals. Wi-Fi is commonly used as wireless extensions to fixed broadband access, e.g., in domestic environments and in so-called hotspots, like airports, train stations and restaurants.

Recently, Wi-Fi has been subject to increased interest from cellular network operators, who are studying the possibility of using Wi-Fi for purposes beyond its conventional role as an extension to fixed broadband access. These operators are responding to the ever-increasing market demands for wireless bandwidth, and are interested in using Wi-Fi technology as an extension of, or alternative to, cellular radio access network technologies (RATs). Network operators that are currently serving mobile users with, for example, any of the technologies standardized by the 3rd-Generation Partnership Project (3GPP), including the radio-access technologies known as Long-Term Evolution (LTE), Universal Mobile Telecommunications System (UMTS)/Wideband Code-Division Multiple Access (WCDMA), and Global System for Mobile Communications (GSM), see Wi-Fi as a wireless technology that can provide good additional support for users in their regular cellular networks.

In particular, cellular network operators are seeking ways to offload traffic from their cellular networks to Wi-Fi, e.g. in peak-traffic-hours and in situations when the cellular network for one reason or another needs to be off-loaded, e.g. to provide requested quality of service, maximise bandwidth or simply for coverage.

Portable wireless devices or terminal devices (also referred to in 3GPP as user equipments—UEs) today usually support both Wi-Fi and a number of 3GPP cellular technologies, but many of the terminal devices are effectively behaving as two separate devices from a radio access perspective. The 3GPP radio access network (RAN) and the modems and protocols that are operating pursuant to the 3GPP specifications are basically unaware of the wireless access Wi-Fi protocols and modems that are operating pursuant to the 802.11 specifications.

Techniques for access network selection (i.e. the selection of which type of network, e.g. 3GPP or WLAN, a UE should access or connect to) and traffic steering (i.e. the selection of a network to be used for a particular data flow) are being discussed and agreed in 3GPP.

Another way in which cellular network operators intend to use Wi-Fi is to use aggregation. 3GPP/WLAN aggregation is a feature whereby a UE may at least receive (and possibly also transmit) data using links to both the 3GPP network and a WLAN. This is similar in principle to dual connectivity LTE, but it aggregates carriers from different radio access technologies (RATs), e.g. a 3GPP network and Wi-Fi. 3GPP/WLAN aggregation is currently being standardized by 3GPP in Release 13 as part of “LTE-WLAN Radio Level Integration and Interworking Enhancement”, RP-150510 which was submitted to 3GPP TSG RAN Meeting #67 in Shanghai, China on 9-12 Mar. 2015.

In a split bearer architecture option for LTE/WLAN aggregation in the downlink, data is split on a packet data convergence protocol (PDCP) layer in the eNB (which is a term used to describe a radio base station in LTE). The eNB may route PDCP packet data units (PDUs) dynamically via eNB radio link control (RLC) to the UE directly, or via a backhaul channel to WLAN and then to the UE. In a separate bearer architecture option, the lower layers of a bearer are switched to LTE or WLAN meaning all PDCP packets of that bearer are routed via either LTE or the WLAN side.

FIG. 1 shows an exemplary protocol architecture for LTE/WLAN aggregation and illustrates a protocol architecture for the eNB 2, a “WLAN termination point” 4 and a UE 6. Other protocol architectures are also being considered. The WLAN termination point 4 in the network is denoted WLAN termination (WT) and may be implemented by a WLAN access point (AP) and/or access controller (AC) or another network node. The interface protocol between eNB 2 and WT 4 is denoted Xw and is used to exchange control plane and user plane information between the eNB 2 and WT 4.

For mobility, it is envisaged that the eNB or other network node in the 3GPP network is in control of which WLANs a UE should use for aggregation. However, the UE is in control of which node is actually used for aggregation and/or which network is selected for access and which network node traffic is steered to. Thus, an eNB or other network node can provide the UE with a set of WLANs or WLAN nodes that the UE can consider when deciding which node to use for aggregation. In some case the decision on which node is used for aggregation may be transparent to the eNB. This set, or a similar set, may also be used when performing access network selection or traffic steering. The set may be provided in the form of a set of identifiers for the WLANs or WLAN nodes, which may be Service Set Identifiers (SSIDs), Extended SSIDs (ESSIDs), Homogeneous ESSIDs (HESSIDs), Basic SSIDs (BSSIDs), or a realm identifier. This set is referred to herein as a mobility set or a mobility set.

### SUMMARY

It may be necessary to manage the content of the set of identifiers so that the set contains appropriate identifiers. For example, as a UE moves through a network, it may be necessary to manage the content of the set of identifiers so that the set contains identifiers that are appropriate for the UE's location. As another example, the particular WLAN(s) near to the UE that are available for the UE to use for aggregation may change over time (e.g. WLANs or WLAN APs may be activated or deactivated).

Thus, the techniques described herein provide ways to manage the content of a set of identifiers stored in a terminal device, and provide for certain actions to be taken in the event of a change in the content of the set of identifiers.

A first embodiment provides a method of operating a terminal device, the terminal device being capable of access network selection, traffic steering and/or traffic aggregation through a network node in a first network operating according to a first radio access technology, RAT, and a network node operating according to a second RAT. The method in this embodiment comprises storing a set of identifiers of network nodes operating according to the second RAT that can be used for access network selection, traffic steering and/or traffic aggregation; receiving an update signal, the update signal indicating one or more identifiers of network nodes operating according to the second RAT that are to be added to and/or removed from the stored set of identifiers; updating the stored set of identifiers based on the update signal; and performing an action using the updated set of identifiers.

A second embodiment provides a computer program product comprising a computer readable medium having computer readable code embodied therein, the computer readable code being configured such that, on execution by a suitable computer or processor, the computer or processor is caused to perform the method described above.

A third embodiment provides a terminal device that is capable of access network selection, traffic steering and/or traffic aggregation through a network node in a first network operating according to a first radio access technology, RAT, and a network node operating according to a second RAT. In this embodiment the terminal device is adapted to store a set of identifiers of network nodes operating according to the second RAT that can be used for access network selection, traffic steering and/or traffic aggregation; receive an update signal, the update signal indicating one or more identifiers of network nodes operating according to the second RAT that are to be added to and/or removed from the stored set of identifiers; update the stored set of identifiers based on the update signal; and perform an action using the updated set of identifiers.

A fourth embodiment provides a method of operating a network node in a first network operating according to a first radio access technology, RAT, wherein a terminal device in the first network is connected to the first network and a first network node operating according to a second RAT, the terminal device using the first network node for traffic steering or traffic aggregation, the method comprising receiving an indication that the terminal device was connected to a first network node operating according to the second RAT that has been removed from a set of identifiers of network nodes operating according to the second RAT that the terminal device was using for access network selection, traffic steering or traffic aggregation; and suspending the traffic steering or traffic aggregation for the terminal device.

A fifth embodiment provides a computer program product comprising a computer readable medium having computer readable code embodied therein, the computer readable code being configured such that, on execution by a suitable computer or processor, the computer or processor is caused to perform the method described above.

A sixth embodiment provides a network node for use in a first network operating according to a first radio access technology, RAT, wherein a terminal device in the first network is connected to the first network and a first network node operating according to a second RAT, the terminal device using the first network node for traffic steering or traffic aggregation, the network node being adapted to receive an indication that the terminal device was connected to a first network node operating according to the second RAT that has been removed from a set of identifiers of network nodes operating according to the second RAT that the terminal device was using for access network selection, traffic steering and/or traffic aggregation; and suspend the traffic steering or traffic aggregation for the terminal device.

A seventh embodiment provides a method of operating a terminal device, the terminal device being capable of access network selection, traffic steering and/or traffic aggregation through a network node in a first network operating according to a first radio access technology, RAT, and a network node operating according to a second RAT, the method comprising on or following disconnection of the terminal device from a first network node operating according to the second RAT that was used for traffic steering or traffic aggregation, performing a procedure to prevent the loss of data packets sent to the first network node by the terminal device or a network node in the first network prior to the disconnection.

An eighth embodiment provides a computer program product comprising a computer readable medium having computer readable code embodied therein, the computer readable code being configured such that, on execution by a suitable computer or processor, the computer or processor is caused to perform the method described above.

A ninth embodiment provides a terminal device that is capable of access network selection, traffic steering and/or traffic aggregation through a network node in a first network operating according to a first radio access technology, RAT, and a network node operating according to a second RAT, the terminal device being adapted to, on or following disconnection of the terminal device from a first network node operating according to the second RAT that was used for traffic steering or traffic aggregation, perform a procedure to prevent the loss of data packets sent to the first network node by the terminal device or a network node in the first network prior to the disconnection.

According to a tenth embodiment there is provided a method of operating a terminal device, the terminal device being capable of access network selection, traffic steering and/or traffic aggregation through a network node in a first network operating according to a first radio access technology, RAT, and a network node operating according to a second RAT. The method comprises storing a set of identifiers of network nodes operating according to the second RAT that can be used for access network selection, traffic steering and/or traffic aggregation; receiving an update signal, the update signal indicating one or more identifiers of network nodes operating according to the second RAT that are to be added to and/or removed from the stored set of identifiers; updating the stored set of identifiers based on the update signal; and performing an action using the updated set of identifiers; wherein, when the stored set of identifiers comprises two or more identifiers and the update signal indicates one or more identifiers of network nodes operating according to the second RAT that are to be removed from the stored set of identifiers such that the updated set of identifiers comprises one or more identifiers of network nodes operating according to the second RAT, the action comprises attempting to connect to, or maintaining a connection to, a network node operating according to the second RAT having an identifier in the updated set of identifiers.

According to an eleventh embodiment there is provided a terminal device that is capable of access network selection, traffic steering and/or traffic aggregation through a network node in a first network operating according to a first radio access technology, RAT, and a network node operating according to a second RAT. The terminal device is adapted to store a set of identifiers of network nodes operating according to the second RAT that can be used for access network selection, traffic steering and/or traffic aggregation; receive an update signal, the update signal indicating one or more identifiers of network nodes operating according to the second RAT that are to be added to and/or removed from the stored set of identifiers; update the stored set of identifiers based on the update signal; and perform an action using the updated set of identifiers; wherein, when the stored set of identifiers comprises two or more identifiers and the update signal indicates one or more identifiers of network nodes operating according to the second RAT that are to be removed from the stored set of identifiers such that the updated set of identifiers comprises one or more identifiers of network nodes operating according to the second RAT, the action comprises attempting to connect to, or maintaining a connection to, a network node operating according to the second RAT having an identifier in the updated set of identifiers.

According to a twelfth embodiment there is provided a method of operating a network node in a first network operating according to a first radio access technology, RAT, wherein a terminal device in the first network is connected to the first network and a first network node operating according to a second RAT, the terminal device using the first network node for traffic steering or traffic aggregation. The method comprises receiving an indication that the terminal device was connected to a first network node operating according to the second RAT that has been removed from a set of identifiers of network nodes operating according to the second RAT that the terminal device was using for access network selection, traffic steering or traffic aggregation; and suspending the traffic steering or traffic aggregation for the terminal device.

According to a thirteenth embodiment there is provided a network node for use in a first network operating according to a first radio access technology, RAT, wherein a terminal device in the first network is connected to the first network and a first network node operating according to a second RAT, the terminal device using the first network node for traffic steering or traffic aggregation. The network node is adapted to receive an indication that the terminal device was connected to a first network node operating according to the second RAT that has been removed from a set of identifiers of network nodes operating according to the second RAT that the terminal device was using for access network selection, traffic steering and/or traffic aggregation; and suspend the traffic steering or traffic aggregation for the terminal device.

According to a fourteenth embodiment there is provided a method of operating a terminal device, the terminal device being capable of access network selection, traffic steering and/or traffic aggregation through a network node in a first network operating according to a first radio access technology, RAT, and a network node operating according to a second RAT. The method comprises, on or following disconnection of the terminal device from a first network node operating according to the second RAT that was used for traffic steering or traffic aggregation, performing a procedure to prevent the loss of data packets sent to the first network node by the terminal device or a network node in the first network prior to the disconnection.

According to a fifteenth embodiment there is provided a terminal device that is capable of access network selection, traffic steering and/or traffic aggregation through a network node in a first network operating according to a first radio access technology, RAT, and a network node operating according to a second RAT. The terminal device is adapted to, on or following disconnection of the terminal device from a first network node operating according to the second RAT that was used for traffic steering or traffic aggregation, perform a procedure to prevent the loss of data packets sent to the first network node by the terminal device or a network node in the first network prior to the disconnection.

According to a sixteenth embodiment there is provided a terminal device that is capable of access network selection, traffic steering and/or traffic aggregation through a network node in a first network operating according to a first radio access technology, RAT, and a network node operating according to a second RAT. The terminal device comprises a processor and a memory, said memory containing instructions executable by said processor whereby said terminal device is operative to store a set of identifiers of network nodes operating according to the second RAT that can be used for access network selection, traffic steering and/or traffic aggregation; receive an update signal, the update signal indicating one or more identifiers of network nodes operating according to the second RAT that are to be added to and/or removed from the stored set of identifiers; update the stored set of identifiers based on the update signal; and perform an action using the updated set of identifiers; wherein, when the stored set of identifiers comprises two or more identifiers and the update signal indicates one or more identifiers of network nodes operating according to the second RAT that are to be removed from the stored set of identifiers such that the updated set of identifiers comprises one or more identifiers of network nodes operating according to the second RAT, the action comprises attempting to connect to, or maintaining a connection to, a network node operating according to the second RAT having an identifier in the updated set of identifiers.

According to a seventeenth embodiment there is provided a network node for use in a first network operating according to a first radio access technology, RAT, wherein a terminal device in the first network is connected to the first network and a first network node operating according to a second RAT, the terminal device using the first network node for traffic steering or traffic aggregation. The network node comprises a processor and a memory, said memory containing instructions executable by said processor whereby said network node is operative to receive an indication that the terminal device was connected to a first network node operating according to the second RAT that has been removed from a set of identifiers of network nodes operating according to the second RAT that the terminal device was using for access network selection, traffic steering and/or traffic aggregation; and suspend the traffic steering or traffic aggregation for the terminal device.

According to an eighteenth embodiment there is provided a terminal device that is capable of access network selection, traffic steering and/or traffic aggregation through a network node in a first network operating according to a first radio access technology, RAT, and a network node operating according to a second RAT. The terminal device comprises a processor and a memory, said memory containing instructions executable by said processor whereby said terminal device is operative to, on or following disconnection of the terminal device from a first network node operating according to the second RAT that was used for traffic steering or traffic aggregation, perform a procedure to prevent the loss of data packets sent to the first network node by the terminal device or a network node in the first network prior to the disconnection.

According to a nineteenth embodiment there is provided a terminal device that is capable of access network selection, traffic steering and/or traffic aggregation through a network node in a first network operating according to a first radio access technology, RAT, and a network node operating according to a second RAT. The terminal device comprises a storing module configured to store a set of identifiers of network nodes operating according to the second RAT that can be used for access network selection, traffic steering and/or traffic aggregation; a receiving module configured to receive an update signal, the update signal indicating one or more identifiers of network nodes operating according to the second RAT that are to be added to and/or removed from the stored set of identifiers; an updating module configured to update the stored set of identifiers based on the update signal; and a performing module configured to perform an action using the updated set of identifiers; wherein, when the stored set of identifiers comprises two or more identifiers and the update signal indicates one or more identifiers of network nodes operating according to the second RAT that are to be removed from the stored set of identifiers such that the updated set of identifiers comprises one or more identifiers of network nodes operating according to the second RAT, the action comprises attempting to connect to, or maintaining a connection to, a network node operating according to the second RAT having an identifier in the updated set of identifiers.

According to a twentieth embodiment there is provided a network node for use in a first network operating according to a first radio access technology, RAT, wherein a terminal device in the first network is connected to the first network and a first network node operating according to a second RAT, the terminal device using the first network node for traffic steering or traffic aggregation. The network node comprises a receiving module configured to receive an indication that the terminal device was connected to a first network node operating according to the second RAT that has been removed from a set of identifiers of network nodes operating according to the second RAT that the terminal device was using for access network selection, traffic steering and/or traffic aggregation; and a suspending module configured to suspend the traffic steering or traffic aggregation for the terminal device.

According to a twenty-first embodiment there is provided a terminal device that is capable of access network selection, traffic steering and/or traffic aggregation through a network node in a first network operating according to a first radio access technology, RAT, and a network node operating according to a second RAT. The terminal device comprises a performing module configured to, on or following disconnection of the terminal device from a first network node operating according to the second RAT that was used for traffic steering or traffic aggregation, perform a procedure to prevent the loss of data packets sent to the first network node by the terminal device or a network node in the first network prior to the disconnection.

According to a twenty-second embodiment there is provided a computer program product comprising a computer readable medium having computer readable code embodied therein, the computer readable code being configured such that, on execution by a suitable computer or processor, the computer or processor is caused to perform any of the method embodiments described above.

### BRIEF DESCRIPTION OF THE DRAWINGS

Features, objects and advantages of the presently disclosed techniques will become apparent to those skilled in the art by reading the following detailed description where references will be made to the appended figures in which:

FIG. 1 illustrates an exemplary protocol architecture for LTE/WLAN aggregation;

FIG. 2 illustrates an LTE network and WLAN APs;

FIG. 3 is a block diagram of a terminal device according to an embodiment;

FIG. 4 is a block diagram of a network node according to an embodiment;

FIG. 5 illustrates a scenario in which the content of a mobility set might be changed;

FIG. 6 is a flow chart illustrating a method of operating a terminal device;

FIG. 7 is a flow chart illustrating a method of operating a network node;

FIG. 8 is a flow chart illustrating another method of operating a terminal device;

FIG. 9 is a block diagram of a terminal device according to another embodiment;

FIG. 10 is a block diagram of a network node according to another embodiment;

FIG. 11 is a block diagram of a terminal device according to yet another embodiment;

FIG. 12 is a block diagram of a network node according to yet another embodiment; and

FIG. 13 is a block diagram of a terminal device according to yet another embodiment.

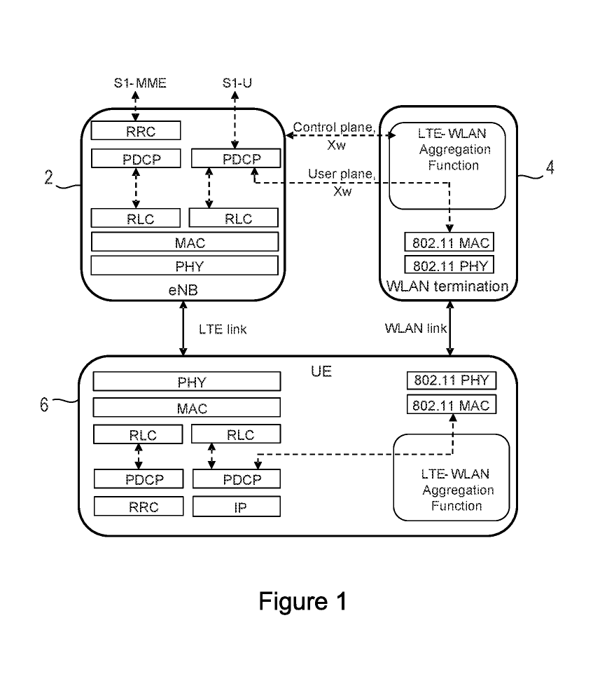

### DETAILED DESCRIPTION

The following sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing units, one or more processing modules or one or more controllers, and the terms computer, processor, processing unit, processing module and controller may be employed interchangeably. When provided by a computer, processor, processing unit, processing module or controller, the functions may be provided by a single dedicated computer, processor, processing unit, processing module or controller, by a single shared computer, processor, processing unit, processing module or controller, or by a plurality of individual computers, processors, processing units, processing modules or controllers, some of which may be shared or distributed. Moreover, these terms also refer to other hardware capable of performing such functions and/or executing software, such as the example hardware recited above.

Although in the description below the term user equipment (UE) is used, it should be understood by the skilled in the art that “UE” is a non-limiting term comprising any mobile or wireless device or node equipped with a radio interface allowing for at least one of: transmitting signals in uplink (UL) and receiving and/or measuring signals in downlink (DL). A UE herein may comprise a UE (in its general sense) capable of operating or at least performing measurements in one or more frequencies, carrier frequencies, component carriers or frequency bands. It may be a “UE” operating in single- or multi-radio access technology (RAT) or multi-standard mode. As well as “UE”, the terms “mobile device” and “terminal device” may be used interchangeably in the following description, and it will be appreciated that such a device does not necessarily have to be ‘mobile’ in the sense that it is carried by a user. Instead, the terms “mobile device” and “terminal device” encompass any device that is capable of communicating with communication networks that operate according to one or more mobile communication standards, such as the Global System for Mobile communications, GSM, UMTS, Long-Term Evolution, LTE, etc.

A cell is associated with a base station, where a base station comprises in a general sense any network node transmitting radio signals in the downlink and/or receiving radio signals in the uplink. Some example base stations, or terms used for describing base stations, are eNodeB, eNB, NodeB, macro/micro/pico/femto radio base station, home eNodeB (also known as femto base station), relay, repeater, sensor, transmitting-only radio nodes or receiving-only radio nodes, or WLAN access point (AP). A base station may operate or at least perform measurements in one or more frequencies, carrier frequencies or frequency bands and may be capable of carrier aggregation. It may also be a single-radio access technology (RAT), multi-RAT, or multi-standard node, e.g., using the same or different base band modules for different RATs.

It should be noted that use of the term “network node” as used herein can refer to a base station, such as an eNodeB, a WLAN AP, a network node in the RAN responsible for resource management, such as a radio network controller (RNC), or, in some cases, a core network node, such as a mobility management entity (MME).

Unless otherwise indicated herein, the signalling described is either via direct links or logical links (e.g. via higher layer protocols and/or via one or more network nodes).

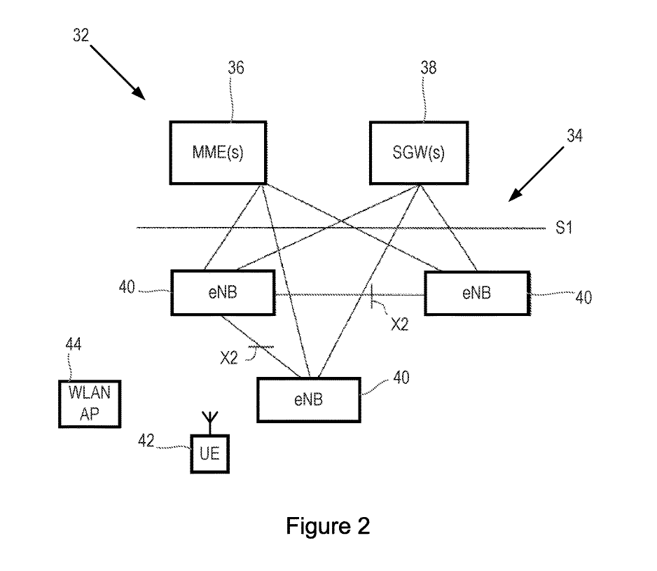

FIG. 2 shows an example diagram of an evolved UMTS Terrestrial Radio Access Network (E-UTRAN) architecture as part of an LTE-based communications system 32 to which the techniques described herein can be applied. Nodes in a core network 34 part of the system 32 include one or more Mobility Management Entities (MMEs) 36, a key control node for the LTE access network, and one or more Serving Gateways (SGWs) 38 which route and forward user data packets while acting as a mobility anchor. They communicate with base stations 40 referred to in LTE as eNBs, over an interface, for example an S1 interface. The eNBs 40 can include the same or different categories of eNBs, e.g. macro eNBs, and/or micro/pico/femto eNBs. The eNBs 40 communicate with each other over an inter-node interface, for example an X2 interface. The S1 interface and X2 interface are defined in the LTE standard. A UE 42 is shown, and a UE 42 can receive downlink data from and send uplink data to one of the base stations 40, with that base station 40 being referred to as the serving base station of the UE 42. Although not part of the E-UTRAN architecture, a WLAN access point (AP) 44 is also shown in FIG. 2. The UE 42 can receive downlink data from and send uplink data to the AP 44.

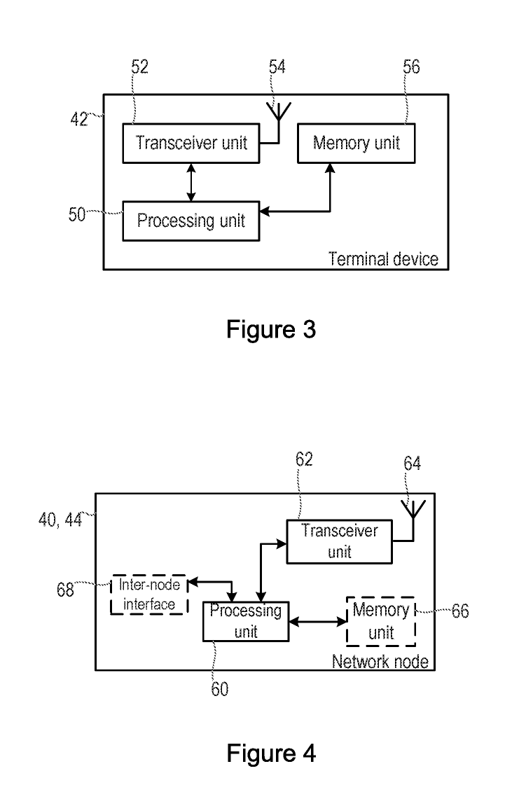

FIG. 3 shows a terminal device (UE) 42 that can be adapted or configured to operate according to one or more of the non-limiting example embodiments described. The UE 42 comprises a processor or processing unit 50 that controls the operation of the UE 42. The processing unit 50 is connected to a transceiver unit 52 (which comprises a receiver and a transmitter) with associated antenna(s) 54 which are used to transmit signals to and receive signals from a base station 40 in the network 32 and to transmit signals to and receive signals from a WLAN AP 44. The UE 42 also comprises a memory or memory unit 56 that is connected to the processing unit 50 and that contains instructions or computer code executable by the processing unit 50 and other information or data required for the operation of the UE 42.

FIG. 4 shows a network node (for example a cellular network base station such as a NodeB or an eNodeB, or a WLAN AP) that can be adapted or configured to operate according to the example embodiments described. The network node 40 comprises a processor or processing unit 60 that controls the operation of the network node 40. The processing unit 60 is connected to a transceiver unit 62 (which comprises a receiver and a transmitter) with associated antenna(s) 64 which are used to transmit signals to, and receive signals from, UEs 42 in the network 32. The network node 40 also comprises a memory or memory unit 66 that is connected to the processing unit 60 and that contains instructions or computer code executable by the processing unit 60 and other information or data required for the operation of the network node 50. The network node 40 also includes components and/or circuitry 68 for allowing the network node 40 to exchange information with another network node 40 (for example via an X2 S1 and/or Xw interface). It will be appreciated that base stations for use in other types of network (e.g. UTRAN or Wideband Code Division Multiple Access (WCDMA) radio access network (RAN)) will include similar components to those shown in FIG. 4 and appropriate interface circuitry 68 for enabling communications with the other network nodes in those types of networks (e.g. other base stations, APs mobility management nodes and/or nodes in the core network).

It will be appreciated that only the components of the UE 42 and network node 40 required to explain the embodiments presented herein are illustrated in FIGS. 3 and 4.

As described above, a terminal device can be provided with a set of identifiers of network nodes that can be considered by the terminal device when performing aggregation, access network selection or traffic steering. This set (or mobility set) may need to be updated over time, and the update to the set may need to be factored into the operation of the terminal device. The techniques described herein provide ways to manage the content of a set of identifiers stored in a terminal device, and provide for certain actions to be taken in the event of a change in the content of the set of identifiers.

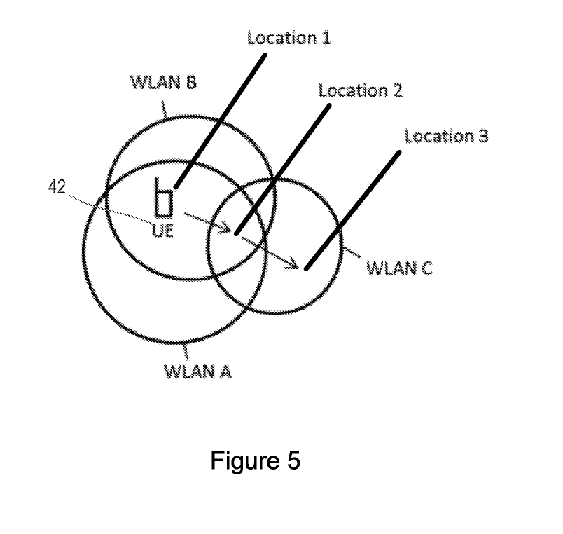

An exemplary scenario in which a mobility set might need to be updated by a cellular network is shown in FIG. 5. FIG. 5 shows three WLANs (WLAN A, WLAN B and WLAN C) and a UE 42. The three WLANs have overlapping coverage areas. The UE 42 is initially at Location 1 which is in the coverage of both WLAN A and WLAN B and it is configured with identifiers for those two WLANs in its mobility set. The UE 42 then moves in the direction indicated by the arrows to Location 2 where the UE 42 is now also in the coverage of WLAN C. A cellular network (not shown) may update the mobility set of the UE 42 by adding also WLAN C to the set so that WLAN C can be considered by the UE 42 when performing traffic steering, access network selection or traffic aggregation. Subsequently the UE 42 moves to Location 3 which is not in the coverage of WLAN A or WLAN B and thus the cellular network may update the mobility set again so that WLAN A and WLAN B are removed from the mobility set. As appreciated by those skilled in the art, the UE 42 may provide measurements of nearby WLANs to the cellular network, and the cellular network (e.g. eNB) may use these measurements to determine which identifiers need to be added to or removed from the mobility set of the UE.

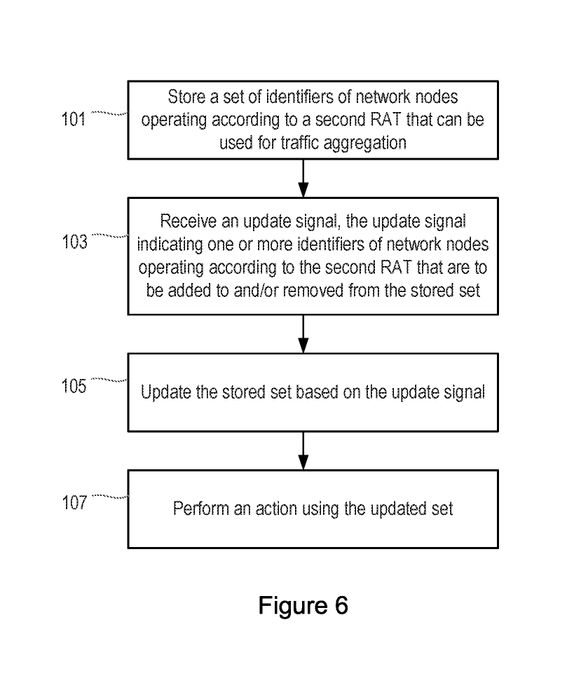

A method of operating a terminal device 42 according to an embodiment is shown in FIG. 6. The terminal device 42 is capable of access network selection, traffic steering and/or traffic aggregation through a network node in a first network operating according to a first radio access technology, RAT, and a network node operating according to a second RAT. The first RAT can be, for example, a cellular communication network technology, such as GSM, UMTS, LTE, etc., or a local area network technology, such as WLAN or Wi-Fi. The second RAT is a different RAT to the first RAT, but can also be any of a cellular communication network technology, such as GSM, UMTS, LTE, etc., or a local area network technology, such as WLAN or Wi-Fi. In a preferred embodiment, the first RAT is a cellular communication network technology, the node in the first network is a base station or eNB, the second RAT is WLAN or Wi-Fi and the node operating according to the second RAT is a WLAN AP or a Wi-Fi AP.

In a first step of the method, the terminal device 42 stores a set of identifiers of network nodes operating according to the second RAT that can be used for access network selection, traffic steering and/or traffic aggregation (step 101). The set (the mobility set) can be stored in the memory unit 56 of the terminal device 42. Each identifier may uniquely identify a network node or a group of network nodes operating according to the second RAT. In the preferred embodiment, each identifier can be an identifier used in WLANs, which includes Service Set Identifiers (SSIDs), Extended SSIDs (ESSIDs), Homogeneous ESSIDs (HESSIDs), Basic SSIDs (BSSIDs), or a realm identifier.

The identifiers in the set may relate to network nodes operating according to the second RAT that are part of a single network (e.g. a second network that is operated by a single WLAN operator). Alternatively the identifiers may relate to network nodes that are in different networks and/or that are ‘stand-alone’ network nodes (i.e. that are not considered part of a wider network of nodes).

The terminal device 42 receives an update signal (step 103). The update signal indicates one or more identifiers of network nodes operating according to the second RAT that are to be added to and/or removed from the stored set of identifiers.

The update signal can be transmitted by a network node in the first network to the UE 42, or it can be transmitted to the UE 42 by a network node operating according to the second RAT.

The terminal device 42 then updates the stored set of identifiers based on the update signal (step 105). In particular, the terminal device 42 adds the required identifiers to the set and/or removes the required identifiers from the set.

The terminal device 42 then performs an action using the updated set of identifiers (step 107). As noted below, the specific action taken by the terminal device 42 depends on the transition of the state of the set before the update to after the update, considering also the connection status of the terminal device 42 at the time of the update to the set. The action may be taken immediately or shortly after the set is updated. Alternatively (for example where the action is to use the updated set in an access network selection, traffic steering and/or traffic aggregation procedure), the action may not be taken immediately, but only when a particular procedure needs to be evaluated.

If the set of identifiers stored in step 101 is empty and comprises no identifiers (i.e. there are no nodes operating according to the second RAT that the terminal device 42 can use for access network selection, traffic steering or traffic aggregation) and the update signal indicates one or more identifiers that are to be added to the set, the action in step 107 can comprise initiating an access network selection, traffic steering and/or traffic aggregation procedure using the identifiers in the updated set. That is, the terminal device 42 can perform the procedure to determine whether the terminal device 42 is to use one of the network nodes operating according to the second RAT having an identifier in the set for traffic to or from the terminal device 42.

If the set of identifiers stored in step 101 is not empty (i.e. it comprises one or more identifiers) and the update signal indicates one or more identifiers that are to be added to the set, the action in step 107 can comprise determining which of the network nodes having an identifier in the updated set of identifiers that the terminal device 42 is to connect to.

If the update signal indicates one or more identifiers are to be removed from the stored set such that the updated set still contains one or more identifiers, the action in step 107 can comprise attempting to connect to, or maintaining a connection to, a network node operating according to the second RAT having an identifier in the updated set.

More particularly, if, prior to the update of the set in step 105, the terminal device 42 is connected to a first network node operating according to the second RAT that has its identifier removed based on the update signal, the action in step 107 can comprise the terminal device 42 disconnecting from the first network node and attempting to connect to a network node operating according to the second RAT that does have an identifier in the updated set. In some embodiments, if this attempt to connect to a network node is unsuccessful, the terminal device 42 can send a failure indication to the first network. As an example, consider a set that comprises identifiers WLAN A and WLAN B prior to a set update, with the terminal device 42 being connected to WLAN A prior to the update. The update results in WLAN A being removed from the set and WLAN C being added. The terminal device 42 will therefore disconnect from WLAN A and try to connect to one or WLAN B or WLAN C.

If, prior to the update of the set in step 105, the terminal device 42 is connected to a first network node operating according to the second RAT whose identifier remains in the updated set after the update in step 105, the action in step 107 can comprise maintaining the connection to the first network node. Alternatively, or subsequently, the action in step 107 can comprise determining a network node operating according to the second RAT to connect to from the network nodes having an identifier in the updated set. This action can be performed by evaluating an access network selection, traffic steering or traffic aggregation procedure. As an example, consider a set that comprises identifiers WLAN A and WLAN B prior to a set update, with the terminal device 42 being connected to WLAN A prior to the update. The update results in WLAN B being removed from the set and WLAN C being added. The terminal device 42 can therefore either maintain the connection to WLAN A or try to connect to WLAN C.

If prior to the updating the terminal device 42 is connected to a first network node operating according to the second RAT and the update signal results in an updated set that is empty (i.e. it comprises no identifiers), the action in step 107 can comprise the terminal device 42 disconnecting from the first network node. In some embodiments this disconnection may also result in access network selection, traffic steering and/or traffic aggregation being suspended or stopped, with the terminal device 42 changing to a single connectivity mode with the first network.

In any of the embodiments above where the terminal device 42 disconnects from a network node operating according to the second RAT as a result of the updating of the stored set, or where the update results in access network selection, traffic steering and/or traffic aggregation being suspended or stopped, the terminal device 42 and/or the first network can perform a procedure to prevent loss of data packets due to the disconnection. Exemplary procedures may comprise retransmission of packet data convergence protocol, PDCP, PDUs, transmission of a PDCP status report (as described in 3GPP TS 36.323 V12.4.0, Section 5.3), a PDCP data recovery procedure (as described in 3GPP TS 36.323 V12.4.0, Section 5.9) or a PDCP reestablishment procedure (as described in 3GPP TS 36.323 V12.4.0, Section 5.2). When the UE is requested to perform the PDCP data recovery procedure, the UE compiles and sends a PDCP status report to the eNB (if configured) and performs retransmissions of all PDCP PDUs that had not been confirmed to be successfully delivered and that had been previously submitted to a re-established RLC entity. In a traffic aggregation scenario between LTE and WLAN, the PDCP data recovery procedure may be modified so that retransmissions are done of all PDCP PDUs that had not been confirmed to be successfully delivered and that had been previously submitted to WLAN for transmission to the disconnected node operating in WLAN. In the PDCP reestablishment procedure (compared to the PDCP data recovery procedure), the UE is additionally configured to receive PDCP PDUs from the eNB out of order, to prevent data loss of downlink data, as well as to reset ciphering key and algorithm (if configured). The particular procedure to use (or even whether a procedure is to be used at all) can be preconfigured in the terminal device 42, or be indicated to the terminal device 42 by the first network, for example in the update signal.

In some embodiments, after the step of updating the stored set, the terminal device 42 can send a signal to the first network indicating whether the terminal device 42 was connected to a network node having an identifier that was removed from the stored set.

In the following embodiments, the first network is a 3GPP network, the terminal device 42 is a UE, the UE 42 is connected to an eNB 40 in the first network, the second RAT is WLAN, and the set of identifiers (the mobility set) is used by the UE 42 to determine which WLAN AP 44 should be used for access network selection, traffic steering and/or traffic aggregation. However, it will be appreciated that the following embodiments are also more generally applicable to other types of RATs and network nodes.

In embodiments described herein, an eNB 40 can add and remove WLAN identifiers from a mobility set stored in a UE 42, and thus control the mobility of the UE 42. The mobility set allows the UE 42 to move between WLAN APs 44 which have identifiers matching those in the mobility set based on, for example, UE-implementation specific and/or WLAN controlled mobility decision mechanisms. The mobility of the UE may be restricted to those WLAN APs having an identifier in the mobility set, i.e. the UE may not be allowed to move to WLANs that do not match the provided identifiers. The exemplary described actions of the UE 42 following the adding and/or removing of WLAN identifiers helps to ensure seamless mobility and efficient retransmissions, which also improves the end user performance.

### Addition of WLAN Identifiers to the Mobility Set

There are two possible exemplary actions for the UE 42 when it receives a configuration or signal from the eNB 40 that adds WLAN identifier(s) to the mobility set.

In one case, if the current UE mobility set (i.e. the mobility set prior to the update) is empty and the eNB 40 adds one or more WLAN identifiers to the set, then the UE 42 shall initiate aggregation over a WLAN AP 44 in the mobility set. That means that the UE 42 starts to connect to a WLAN AP 44 in the set. Starting to connect and connect includes, for example, authenticating and associating with one of the APs 44 corresponding to the WLAN identifiers.

In another case, if the UE mobility set is not empty prior to the update, the addition of WLAN identifier(s) by the eNB 40 is considered an update and the UE 42 may consider that WLAN AP 44 as a part of mobility set from then on. This implies that the UE 42 is allowed to change WLAN to the WLAN(s) newly-added to the mobility set. It will be appreciated that the addition of identifiers to the mobility set does not automatically require the UE 42 to re-evaluate which WLAN AP 44 it is using, and does not always result in a change in WLAN AP 44 even when that re-evaluation is performed. It will also be appreciated that UE mobility among the WLAN APs 44 may be transparent to the eNB 40.

Removal of WLAN Identifiers from the Mobility Set

There are a number of possible exemplary actions for the UE 42 when it receives a configuration or signal from the eNB 40 that removes WLAN identifier(s) from the mobility set.

Where the mobility set is not empty following removal of the specified WLAN identifiers, the action taken by the UE 42 depends on whether the UE 42 is connected to a WLAN AP 42 whose WLAN identifier was removed from the mobility set. In principle, the UE 42 performs the removal of the specified WLAN identifiers from the mobility set and if the set is non-empty then the UE 42 shall perform actions to ensure that the UE 42 is connected to a WLAN AP 44 having an identifier in the updated mobility set.

### UE is Connected to a Removed WLAN—

If the UE 42 is connected to a WLAN AP 44 whose identifier is removed from the mobility set, then the UE 42 will select another WLAN AP 44 that is in the updated mobility set. If the UE 42 can connect to the selected WLAN AP 44 then access network selection, traffic steering and/or traffic aggregation may continue through this selected WLAN AP 44.

Optionally, when the UE 42 successfully connects to the other WLAN AP 44, the UE 42 can perform a procedure to prevent data loss, for example retransmissions of PDCP PDUs, transmission of a PDCP status report, a PDCP data recovery procedure or a PDCP reestablishment procedure to ensure that no UL and/or DL data is lost during the change of the WLAN AP 44. This may be beneficial if a WLAN internal mechanism has difficulties in providing lossless mobility, or if it would take too long.

If the UE 42 does not manage to connect to another WLAN AP 44 having an identifier in the mobility set, then the UE 42 may send a failure indication to the 3GPP network so that the 3GPP network will know that access network selection, traffic steering and/or traffic aggregation should be stopped, or, for example, that a further update of the WLAN mobility set needs to be performed.

If the UE 42 fails to connect to another WLAN AP 44, the UE 42 should perform a procedure to prevent data loss, for example retransmission of PDCP PDUs, or PDCP data recovery procedure (or PDCP reestablishment procedure) to ensure that no data is lost. With these procedures it is ensured that no UL and/or DL data is lost, for example by retransmitting UL data via LTE that had been previously transmitted via WLAN, and for example by receiving DL retransmissions/out of order transmissions via LTE that had been previously transmitted via WLAN. In addition, a PDCP status report can be transmitted to the LTE network to indicate which PDCP PDUs had already been received in the downlink, and which had been lost on the way via the WLAN AP whose identifier had been removed.

In a further embodiment the eNB 40 can configure the UE 42 as to whether a procedure to prevent data loss should be executed, for example whether one or more of or none of retransmissions of PDCP PDUs, transmission of PDCP status report, PDCP data recovery or PDCP reestablishment should be executed by the UE 42. This configuration may be given in an information element or field of a radio resource control (RRC) message. Alternatively this configuration can be specified in a standard.

In some embodiments, the UE 42 can send an indication to the eNB 40 that it was connected to a WLAN AP 44 that has been removed from the set of identifiers as a result of the update signal.

In some embodiments, for example where the UE 42 is steering traffic to/from the WLAN AP 44, or the UE 42 is using the WLAN AP 44 for traffic aggregation, the UE 42 may receive a signal from the 3GPP network (e.g. from eNB 40) indicating that the traffic steering or traffic aggregation (as appropriate) is being stopped or suspended. Where the traffic steering or traffic aggregation is to be stopped or suspended as a result of this signal, the UE 42 can perform a procedure to prevent the loss of any data packets, for example retransmissions of PDCP PDUs, transmission of a PDCP status report, PDCP data recovery or PDCP reestablishment.

### UE is not Connected to Removed WLAN—

If the UE 42 is connected to a WLAN AP 44 whose identifier was not removed from the mobility set, the UE can keep the connection to that WLAN AP 44 (although, as described earlier, the UE 42 is allowed to connect to any WLAN AP 44 having an identifier in the mobility set, and the UE 42 is allowed to change WLAN at any time).

In some embodiments the UE 42 can indicate to the 3GPP network (e.g. eNB 40) whether or not the UE 42 was connected to a WLAN AP 44 whose identifier was removed. This information may be used by the 3GPP network to, for example, suspend aggregation or traffic steering (if appropriate). The aggregation or traffic steering may then be resumed when the 3GPP network determines that the UE 42 has connected to an alternative WLAN AP 44. The suspension may be temporary, e.g. the eNB 40 may stop forwarding PDCP PDUs for transmission to the WLAN AP 44 in the network.

In this embodiment, the 3GPP network may determine that the UE 42 has connected to another WLAN AP 44 based on an indication received from the UE 42, e.g. the UE 42 may indicate to the eNB 40 that the UE 42 has (or will shortly) connect to another WLAN AP 44 and hence the aggregation or traffic steering can resume.

It is possible that the UE 42 only sends the indication if the UE 42 was connected to a WLAN AP 44 that has been removed from the mobility set and the absence of this indication implies to the 3GPP network that the UE 42 was not connected to the removed WLAN AP 44, or vice versa that the UE 42 sends the indication if the UE 42 was not connected to the removed WLAN AP 44 and the absence of such an indication implies to the 3GPP network that the UE 42 was not connected to the removed WLAN AP 44. In an alternative approach, the UE 42 can always send the indication and explicitly indicate whether or not it was connected to the WLAN AP or a WLAN AP that was removed from the mobility set.

In another embodiment, the eNB 40 may determine that the UE 42 has connected to another WLAN AP by determining that a time T has passed since the WLAN identifier was removed (i.e. since the update signal was sent to the UE 42). The value T may be specified in a specification, indicated to the 3GPP network by the UE 42, or configured by the 3GPP network. Alternatively, the eNB 40 may determine that the UE 42 has connected to another WLAN AP by a flow-control mechanism that dictates that the eNB 40 should send data to the UE 42 over a WLAN AP 44. For example, the WLAN AP 44 in the network may determine that the UE 42 had connected and then request data for transmission to the UE 42 from the eNB 40 within a flow control mechanism.

### Resulting Mobility Set is Empty—

If the mobility set is empty after the removal of the WLAN identifier(s) according to the update signal and the UE 42 is connected to a WLAN AP 44 and aggregating traffic through the 3GPP network and the WLAN AP 44, the UE 42 should stop access network selection, traffic steering and/or traffic aggregation. In addition, the UE should perform a procedure to prevent data loss, for example retransmissions of PDCP PDUs, or PDCP data recovery procedure so that, for example, UL transmissions that have been lost on the WLAN AP whose identifier has been removed are retransmitted via the 3GPP network to the PDCP receiver. Alternatively, a PDCP reestablishment procedure may be used. Furthermore, a PDCP status report may be sent. The use of these procedures by the UE 42 may be configurable by RRC or other signalling, or may be specified in a standard.

### Suspension/Stopping of Traffic Steering/Traffic Aggregation by an eNB

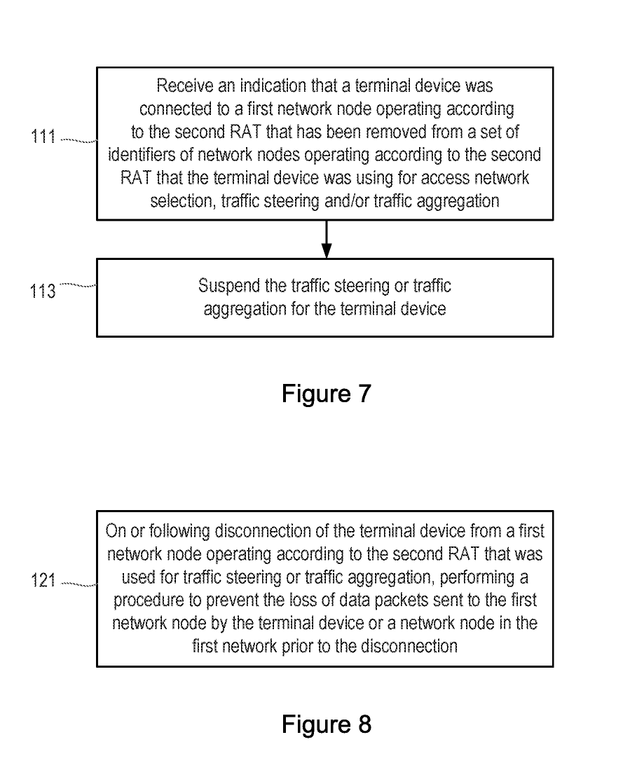

The flow chart in FIG. 7 illustrates an exemplary method of operating a network node according to a specific embodiment. In this method the network node is a network node (e.g. an eNB 40 in the radio access network or a MME 36 or SGW 38 in the core network) in a first network (e.g. a 3GPP network) operating according to a first RAT (e.g. a 3GPP RAT). A terminal device 42 is connected to the first network via the node performing the method (in the case that the method is performed by an eNB 40) or via another network node in the first network (in the case that the method is performed by a core network node 36, 38) and (prior to receipt of an update signal) a network node 44 (e.g. a WLAN AP) operating according to a second RAT (e.g. WLAN or Wi-Fi). The terminal device 42 may be using traffic aggregation to transmit and/or receive data via the first network and the network node 44 that is operating according to the second RAT. Alternatively, the terminal device 42 may be steering traffic (e.g. data) to the first network via the network node 44, and/or the first network may be steering traffic to the terminal device 42 via the network node 44.

In a first step, step 111, the method comprises receiving an indication from a terminal device that the terminal device was connected to a first network node operating according to the second RAT that has been removed from a set of identifiers of network nodes operating according to the second RAT that the terminal device was using for access network selection, traffic steering and/or traffic aggregation.

On receipt of this indication, the network node suspends the traffic aggregation or traffic steering (as appropriate) for the terminal device 42 (step 113). Traffic aggregation and traffic steering is suspended to prevent the loss of downlink data to the terminal device 42 after the terminal device 42 disconnects from the first network node 44. In particular, suspending the traffic aggregation and traffic steering can comprise suspending the transmission of terminal device data to the first network node 44.

Step 113 may comprise the network node sending a signal to the terminal device 42 to indicate to the terminal device 42 that the traffic steering or traffic aggregation is being stopped or suspended.

Subsequently, if the network node 40 in the first network determines that the terminal device 42 has connected to a second network node operating according to the second RAT, the network node in the first network can take action to resume traffic steering or traffic aggregation (as appropriate) for the terminal device 42 via the first network and the second network node 44. The network node 40 in the first network can determine that the terminal device 42 has connected to a second network node 44 if a predetermined time period has elapsed since the indication was received from the terminal device 42. Alternatively (in the case of traffic aggregation), the network node 40 in the first network can determine that the terminal device 42 has connected to a second network node 44 if an indication is received from a flow control mechanism that data for the terminal device 42 is to be sent to the second network node 44. Another alternative is that the network node 40 in the first network receives an indication from the terminal device 42 indicating that the terminal device 42 has connected to a second network node 44.

### Performing a Procedure to Prevent Data Loss in the Event of WLAN Mobility

It is noted above that in certain embodiments where the UE 42 disconnects from a WLAN AP 44 as a result of the update to the set of identifiers, the UE 42 may perform a procedure to prevent the loss of data packets that may have been sent to that WLAN AP 44 by the 3GPP network or the UE 42 as part of traffic steering or traffic aggregation that was in place prior to the disconnection. This procedure is thus performed in response to WLAN mobility that occurs in response to a change in the content of the mobility set as a result of receiving an update signal. However, it will be appreciated that a procedure to prevent the loss of data packets can be performed by a UE 42 when any change in WLAN AP occurs (i.e. regardless of whether or not it was as a result of a change in the content of a mobility set). It will also be appreciated that this procedure can be performed regardless of the type of RATs used by the network nodes that the UE 42 is connected to.

An exemplary method of operating a terminal device 42 according to this embodiment is shown in FIG. 8. In this method, the terminal device 42 is capable of access network selection, traffic steering and/or traffic aggregation through a network node in a first network operating according to a first RAT (e.g. an eNB 40 in an LTE network) and a network node operating according to a second RAT (e.g. a WLAN AP 44). On or following the disconnection of the terminal device 42 from a first network node operating according to the second RAT (e.g. first WLAN AP 44) that was used for traffic steering or traffic aggregation, the method comprises the terminal device 42 performing a procedure to prevent the loss of data packets sent to the first network node 44 by the terminal device 42 or a network node 40 in the first network prior to the disconnection (step 121).

The disconnection of the terminal device 42 can be due to a number of reasons. For example, the disconnection could be due to the selection, by the terminal device 42, of another (different) network node 44 operating according to the second RAT that is to be used as the access network, or for traffic steering and/or traffic aggregation. As another example, the disconnection can be due to the removal of an identifier for the first network node 44 from the mobility set for the terminal device 42 (as described above). In yet another example, the disconnection could be due to receipt of a signal from the first network (e.g. LTE network), the first network node (e.g. WLAN AP 44) or another network node operating according to the second RAT (e.g. another WLAN AP 44) indicating that the terminal device 42 is to disconnect from the first network node 44 and/or connect to a different network node 44 operating according to the second RAT. In the latter case, the signal can be a signal indicating to the terminal device 42 that traffic steering or traffic aggregation is to be suspended or stopped.

As noted above, the procedure to prevent the loss of data packets can comprise retransmission of PDCP PDUs, transmission of a PDCP status report, a PDCP data recovery procedure or a PDCP reestablishment procedure. Although not shown in FIG. 8, the method may further comprise the step of the terminal device 42 receiving a signal indicating which of the procedures to prevent data loss, for example retransmissions of PDCP PDUs, transmission of PDCP status report, PDCP data recovery procedure or PDCP reestablishment procedure is to be performed by the terminal device 42 in the event that a procedure to prevent the loss of data packets is to be performed. This signal can be received from a network node (e.g. an eNB 40) in the first network.

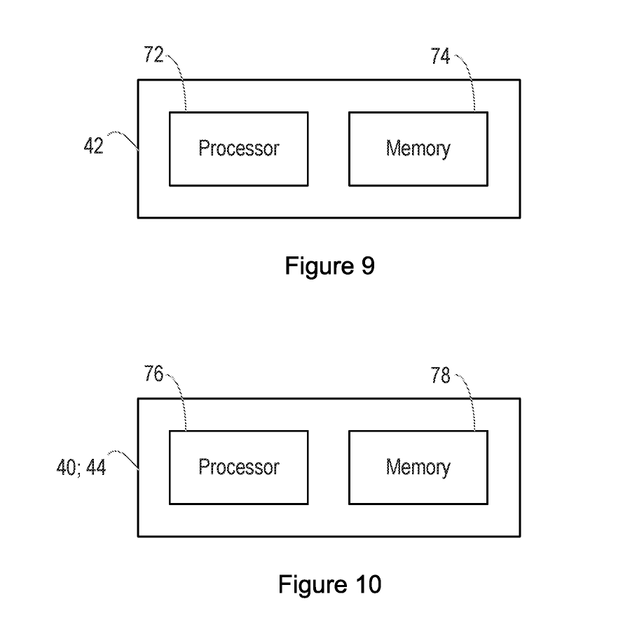

FIG. 9 is a block diagram of an alternative terminal device 42 that can be used in the example embodiments described herein. The terminal device 42 is capable of access network selection, traffic steering and/or traffic aggregation through a network node in a first network operating according to a first RAT and a network node operating according to a second RAT. The terminal device 42 comprises a processor 72 and a memory 74.

In certain embodiments, the memory 74 contains instructions executable by the processor 72, and on execution of those instructions, the terminal device 42 is operative to store a set of identifiers of network nodes operating according to the second RAT that can be used for access network selection, traffic steering and/or traffic aggregation, receive an update signal, the update signal indicating one or more identifiers of network nodes operating according to the second RAT that are to be added to and/or removed from the stored set of identifiers; update the stored set of identifiers based on the update signal; and perform an action using the updated set of identifiers. The terminal device may further be operative such that, when the stored set of identifiers comprises two or more identifiers and the update signal indicates one or more identifiers of network nodes operating according to the second RAT that are to be removed from the stored set of identifiers such that the updated set of identifiers comprises one or more identifiers of network nodes operating according to the second RAT, the action comprises attempting to connect to, or maintaining a connection to, a network node operating according to the second RAT having an identifier in the updated set of identifiers.

In other embodiments, the memory 74 contains instructions executable by the processor 72, and on execution of those instructions, the terminal device 42 is operative to, on or following disconnection of the terminal device from a first network node operating according to the second RAT that was used for traffic steering or traffic aggregation, perform a procedure to prevent the loss of data packets sent to the first network node by the terminal device or a network node in the first network prior to the disconnection.

FIG. 10 is a block diagram of an alternative network node 40, 44 (which, as above, can be a base station 40 or AP 44) that can be used in the example embodiments described herein. The network node 40; 44 is for use in a first network operating according to a first RAT, where a terminal device in the first network is connected to the first network and a first network node operating according to a second RAT, and the terminal device is using the first network node for traffic steering or traffic aggregation.

The network node 40, 44 comprises a processor 76 and a memory 78. The memory 78 contains instructions executable by the processor 76, and on execution of those instructions, the network node 40, 44 is operative to receive an indication that the terminal device was connected to a first network node operating according to the second RAT that has been removed from a set of identifiers of network nodes operating according to the second RAT that the terminal device was using for access network selection, traffic steering and/or traffic aggregation; and suspend the traffic steering or traffic aggregation for the terminal device.

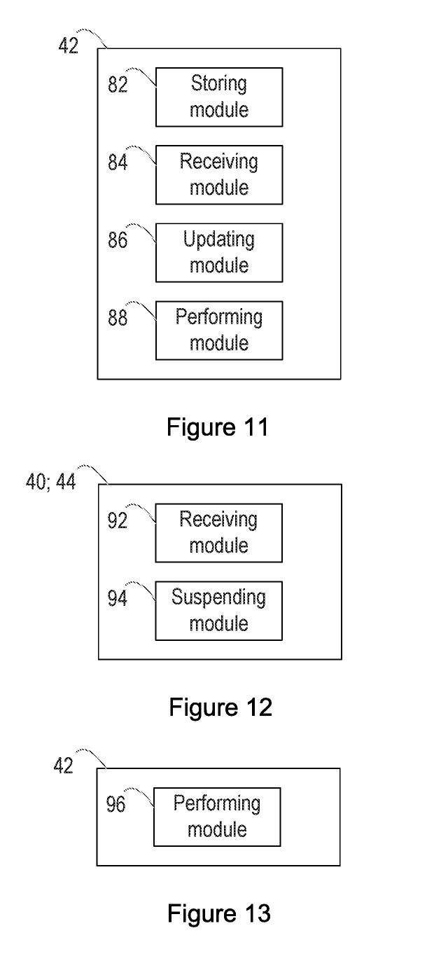

FIG. 11 is a block diagram of another alternative terminal device 42 that can be used in the example embodiments described herein. The terminal device 42 is capable of or configured for access network selection, traffic steering and/or traffic aggregation through a network node in a first network operating according to a first RAT and a network node operating according to a second RAT. The terminal device 42 comprises a storing module 82 configured to store a set of identifiers of network nodes operating according to the second RAT that can be used for access network selection, traffic steering and/or traffic aggregation, a receiving module 84 configured to receive an update signal, the update signal indicating one or more identifiers of network nodes operating according to the second RAT that are to be added to and/or removed from the stored set of identifiers; an updating module 86 configured to update the stored set of identifiers based on the update signal; and a performing module 88 configured to perform an action using the updated set of identifiers. Any one or more of the modules 82, 84, 86 and 88 can be implemented in hardware, software or a combination thereof.

FIG. 12 is a block diagram of another alternative network node 40, 44 (which, as above, can be a base station 40 or AP 44) that can be used in the example embodiments described herein. The network node 40, 44 is for use in a first network operating according to a first RAT, where a terminal device in the first network is connected to the first network and a first network node operating according to a second RAT, and the terminal device is using the first network node for traffic steering or traffic aggregation. The network node 40, 44 comprises a receiving module 92 configured to receive an indication that the terminal device was connected to a first network node operating according to the second RAT that has been removed from a set of identifiers of network nodes operating according to the second RAT that the terminal device was using for access network selection, traffic steering and/or traffic aggregation; and a suspending module 94 configured to suspend the traffic steering or traffic aggregation for the terminal device. Any one or more of the modules 92 and 94 can be implemented in hardware, software or a combination thereof.

FIG. 13 is a block diagram of another alternative terminal device 42 that can be used in the example embodiments described herein. The terminal device 42 is capable of or configured for access network selection, traffic steering and/or traffic aggregation through a network node in a first network operating according to a first RAT and a network node operating according to a second RAT. The terminal device 42 comprises a performing module 96 configured to, on or following disconnection of the terminal device from a first network node operating according to the second RAT that was used for traffic steering or traffic aggregation, perform a procedure to prevent the loss of data packets sent to the first network node by the terminal device or a network node in the first network prior to the disconnection. Performing module 96 can be implemented in hardware, software or a combination thereof.

Thus, there are provided techniques for managing the content of a set of identifiers stored in a terminal device, and for taking certain actions in the event of a change in the content of the set of identifiers.

Modifications and other variants of the described embodiment(s) will come to mind to one skilled in the art having the benefit of the teachings presented in the foregoing descriptions and the associated drawings. Therefore, it is to be understood that the embodiment(s) is/are not to be limited to the specific examples disclosed and that modifications and other variants are intended to be included within the scope of this disclosure. Although specific terms may be employed herein, they are used in a generic and descriptive sense only and not for purposes of limitation.

Various exemplary embodiments are set out in the following statements:
1. A method of operating a terminal device, the terminal device being capable of access network selection, traffic steering and/or traffic aggregation through a network node in a first network operating according to a first radio access technology, RAT, and a network node operating according to a second RAT, the method comprising:

storing a set of identifiers of network nodes operating according to the second RAT that can be used for access network selection, traffic steering and/or traffic aggregation;

receiving an update signal, the update signal indicating one or more identifiers of network nodes operating according to the second RAT that are to be added to and/or removed from the stored set of identifiers;

updating the stored set of identifiers based on the update signal; and

performing an action using the updated set of identifiers.

2. A method as defined in statement 1, wherein, when the stored set of identifiers comprises no identifiers and the update signal indicates one or more identifiers of network nodes operating according to the second RAT that are to be added to the stored set of identifiers, the action comprises evaluating an access network selection, traffic steering and/or traffic aggregation procedure to determine whether the terminal device is to use one of the network nodes operating according to the second RAT having an identifier in the updated set of identifiers.
3. A method as defined in statement 1 or 2, wherein, when the stored set of identifiers comprises one or more identifiers and the update signal indicates one or more identifiers of network nodes operating according to the second RAT that are to be added to the stored set of identifiers, the action comprises determining a network node operating according to the second RAT to connect to from the network nodes operating according to the second RAT having an identifier in the updated set of identifiers.
4. A method as defined in statement 1, 2 or 3, wherein, when the stored set of identifiers comprises two or more identifiers and the update signal indicates one or more identifiers of network nodes operating according to the second RAT that are to be removed from the stored set of identifiers such that the updated set of identifiers comprises one or more identifiers of network nodes operating according to the second RAT, the action comprises attempting to connect to, or maintaining a connection to, a network node operating according to the second RAT having an identifier in the updated set of identifiers.
5. A method as defined in statement 4, wherein, in the event that the terminal device is connected to a first network node operating according to the second RAT having an identifier in the stored set that is removed based on the update signal and is not in the updated set of identifiers, the action comprises disconnecting from the first network node and attempting to connect to a network node operating according to the second RAT having an identifier in the updated set of identifiers.
6. A method as defined in statement 5, wherein in the event that the attempt to connect to a network node operating according to the second RAT having an identifier in the updated set of identifiers is unsuccessful, the method further comprises:

sending a failure indication to the first network.

7. A method as defined in any of statements 4-6, wherein, in the event that the terminal device is connected to a first network node operating according to the second RAT having an identifier in the stored set of identifiers and in the updated set of identifiers, the action comprises maintaining the connection to the first network node, or determining a network node operating according to the second RAT to connect to from the network nodes operating according to the second RAT having an identifier in the updated set of identifiers.
8. A method as defined in any of statements 1-7, wherein the update signal indicates one or more identifiers of network nodes operating according to the second RAT that are to be removed from the stored set of identifiers such that the updated set of identifiers comprises no identifiers, wherein prior to the updating the terminal device is connected to a first network node operating according to the second RAT, and wherein the action comprises disconnecting from the first network node.
9. A method as defined in any of statements 5, 6 or 8, wherein, in the event that the terminal device was using the first network node for traffic steering and/or traffic aggregation, the method further comprises:

receiving a signal from the first network indicating that the traffic steering and/or traffic aggregation is to be suspended or stopped.

10. A method as defined in statement 5, 6, 8 or 9, wherein the method further comprises:

performing a procedure to prevent loss of data packets due to the disconnection from the first network node.

11. A method as defined in statement 10, wherein the procedure comprises a retransmission of packet data convergence protocol, PDCP, packet data units, PDUs, transmission of a PDCP status report, PDCP data recovery procedure or a PDCP reestablishment procedure.
12. A method as defined in statement 11, wherein the method further comprises the step of receiving a signal indicating which of the procedure for retransmission of PDCP PDUs, transmission of PDCP status report, PDCP data recovery procedure or PDCP reestablishment procedure is to be performed by the terminal device.
13. A method as defined in any of statements 4-12, the method further comprising the step of:

sending a signal to the first network indicating whether the terminal device was connected to a network node operating according to the second RAT having an identifier that was removed from the stored set of identifiers.

14. A computer program product comprising a computer readable medium having computer readable code embodied therein, the computer readable code being configured such that, on execution by a suitable computer or processor, the computer or processor is caused to perform the method of any of statements 1-13.
15. A terminal device that is capable of access network selection, traffic steering and/or traffic aggregation through a network node in a first network operating according to a first radio access technology, RAT, and a network node operating according to a second RAT, the terminal device being adapted to:

store a set of identifiers of network nodes operating according to the second RAT that can be used for access network selection, traffic steering and/or traffic aggregation;

receive an update signal, the update signal indicating one or more identifiers of network nodes operating according to the second RAT that are to be added to and/or removed from the stored set of identifiers;

update the stored set of identifiers based on the update signal; and

perform an action using the updated set of identifiers.

16. A terminal device as defined in statement 15, wherein, when the stored set of identifiers comprises no identifiers and the update signal indicates one or more identifiers of network nodes operating according to the second RAT that are to be added to the stored set of identifiers, the action comprises evaluating an access network selection, traffic steering and/or traffic aggregation procedure to determine whether the terminal device is to use one of the network nodes operating according to the second RAT having an identifier in the updated set of identifiers.
17. A terminal device as defined in statement 15 or 16, wherein, when the stored set of identifiers comprises one or more identifiers and the update signal indicates one or more identifiers of network nodes operating according to the second RAT that are to be added to the stored set of identifiers, the action comprises determining a network node operating according to the second RAT to connect to from the network nodes operating according to the second RAT having an identifier in the updated set of identifiers.
18. A terminal device as defined in statement 15, 16 or 17, wherein, when the stored set of identifiers comprises two or more identifiers and the update signal indicates one or more identifiers of network nodes operating according to the second RAT that are to be removed from the stored set of identifiers such that the updated set of identifiers comprises one or more identifiers of network nodes operating according to the second RAT, the action comprises attempting to connect to, or maintaining a connection to, a network node operating according to the second RAT having an identifier in the updated set of identifiers.
19. A terminal device as defined in statement 18, wherein, in the event that the terminal device is connected to a first network node operating according to the second RAT having an identifier in the stored set that is removed based on the update signal and is not in the updated set of identifiers, the action comprises disconnecting from the first network node and attempting to connect to a network node operating according to the second RAT having an identifier in the updated set of identifiers.
20. A terminal device as defined in statement 19, wherein the terminal device is further adapted to send a failure indication to the first network in the event that the attempt to connect to a network node operating according to the second RAT having an identifier in the updated set of identifiers is unsuccessful.
21. A terminal device as defined in any of statements 18-20, wherein, in the event that the terminal device is connected to a first network node operating according to the second RAT having an identifier in the stored set of identifiers and in the updated set of identifiers, the action comprises maintaining the connection to the first network node, or determining a network node operating according to the second RAT to connect to from the network nodes operating according to the second RAT having an identifier in the updated set of identifiers.
22. A terminal device as defined in any of statements 15-21, wherein the update signal indicates one or more identifiers of network nodes operating according to the second RAT that are to be removed from the stored set of identifiers such that the updated set of identifiers comprises no identifiers, wherein prior to the updating the terminal device is connected to a first network node operating according to the second RAT, and wherein the action comprises disconnecting from the first network node.
23. A terminal device as defined in any of statements 19, 20 or 22, wherein the terminal device is further adapted to receive a signal from the first network indicating that traffic steering and/or traffic aggregation to the first network node is to be suspended or stopped.
24. A terminal device as defined in statement 19, 20, 22 or 23, wherein the terminal device is further adapted to perform a procedure to prevent loss of data packets due to the disconnection from the first network node.
25. A terminal device as defined in statement 24, wherein the procedure comprises retransmission of packet data convergence protocol, PDCP, packet data units, PDUs, transmission of PDCP status report, PDCP data recovery procedure or a PDCP reestablishment procedure.
26. A terminal device as defined in statement 25, wherein the terminal device is further adapted to receive a signal indicating which of the procedure for retransmission of PDCP PDUs, transmission of PDCP status report, PDCP data recovery procedure or PDCP reestablishment procedure is to be performed by the terminal device.
27. A terminal device as defined in any of statements 18-26, wherein the terminal device is further adapted to send a signal to the first network indicating whether the terminal device was connected to a network node operating according to the second RAT having an identifier that was removed from the stored set of identifiers.
28. A method of operating a network node in a first network operating according to a first radio access technology, RAT, wherein a terminal device in the first network is connected to the first network and a first network node operating according to a second RAT, the terminal device using the first network node for traffic steering or traffic aggregation, the method comprising:

receiving an indication that the terminal device was connected to a first network node operating according to the second RAT that has been removed from a set of identifiers of network nodes operating according to the second RAT that the terminal device was using for access network selection, traffic steering or traffic aggregation; and

suspending the traffic steering or traffic aggregation for the terminal device.

29. A method as defined in statement 28, wherein the step of suspending the traffic steering or traffic aggregation comprises suspending the transmission of terminal device data to the first network node.
30. A method as defined in statement 28 or 29, the method further comprising the step of:

determining that the terminal device has connected to a second network node operating according to the second RAT; and

resuming traffic steering or traffic aggregation for the terminal device via the second network node.

31. A method as defined in statement 30, wherein the step of determining that the terminal device has connected to a second network node comprises determining that a predetermined time period has elapsed since the indication was received from the terminal device.
32. A method as defined in statement 30, wherein the step of determining that the terminal device has connected to a second network node comprises receiving an indication from a flow control mechanism that data for the terminal device is to be sent to the second network node.
33. A method as defined in statement 30, wherein the step of determining that the terminal device has connected to a second network node comprises receiving an indication from the terminal device that the terminal device has connected to a second network node.
34. A computer program product comprising a computer readable medium having computer readable code embodied therein, the computer readable code being configured such that, on execution by a suitable computer or processor, the computer or processor is caused to perform the method of any of statements 28-33.
35. A network node for use in a first network operating according to a first radio access technology, RAT, wherein a terminal device in the first network is connected to the first network and a first network node operating according to a second RAT, the terminal device using the first network node for traffic steering or traffic aggregation, the network node being adapted to:

receive an indication that the terminal device was connected to a first network node operating according to the second RAT that has been removed from a set of identifiers of network nodes operating according to the second RAT that the terminal device was using for access network selection, traffic steering and/or traffic aggregation; and

suspend the traffic steering or traffic aggregation for the terminal device.

36. A network node as defined in statement 35, wherein the network node is adapted to suspend the traffic steering or traffic aggregation by suspending the transmission of terminal device data to the first network node.
37. A network node as defined in statement 35 or 36, the network node being further adapted to:

determine that the terminal device has connected to a second network node operating according to the second RAT; and

resume traffic steering or traffic aggregation for the terminal device via the second network node.

38. A network node as defined in statement 37, wherein the network node is adapted to determine that the terminal device has connected to a second network node by determining that a predetermined time period has elapsed since the indication was received from the terminal device.
39. A network node as defined in statement 37, wherein the network node is adapted to determine that the terminal device has connected to a second network node by receiving an indication from a flow control mechanism that data for the terminal device is to be sent to the second network node.
40. A network node as defined in statement 37, wherein the network node is adapted to determine that the terminal device has connected to a second network node by receiving an indication from the terminal device that the terminal device has connected to a second network node.
41. A method of operating a terminal device, the terminal device being capable of access network selection, traffic steering and/or traffic aggregation through a network node in a first network operating according to a first radio access technology, RAT, and a network node operating according to a second RAT, the method comprising:

on or following disconnection of the terminal device from a first network node operating according to the second RAT that was used for traffic steering or traffic aggregation, performing a procedure to prevent the loss of data packets sent to the first network node by the terminal device or a network node in the first network prior to the disconnection.

42. A method as defined in statement 41, wherein the disconnection of the terminal device is due to any one or more of the following reasons:

(i) selection of a second network node operating according to the second RAT by the terminal device to use as the access network, or for traffic steering and/or traffic aggregation;

(ii) the removal of an identifier for the first network node from a set of identifiers of network nodes operating according to the second RAT that can be used for access network selection, traffic steering and/or traffic aggregation; and/or

(iii) receipt of a signal from the first network, the first network node or another network node operating according to the second RAT indicating that the terminal device is to disconnect from the first network node and/or connect to a different network node operating according to the second RAT.

43. A method as defined in statement 41 or 42, wherein the procedure to prevent the loss of data packets comprises retransmission of packet data convergence protocol, PDCP, packet data units, PDUs, transmission of a PDCP status report, a PDCP data recovery procedure or a PDCP reestablishment procedure.
44. A method as defined in statement 43, wherein the method further comprises the step of receiving a signal indicating which of the procedure for retransmissions of PDCP PDUs, transmission of PDCP status report, PDCP data recovery procedure or PDCP reestablishment procedure is to be performed by the terminal device in the event that a procedure to prevent the loss of data packets is to be performed.
45. A computer program product comprising a computer readable medium having computer readable code embodied therein, the computer readable code being configured such that, on execution by a suitable computer or processor, the computer or processor is caused to perform the method of any of statements 41-44.
46. A terminal device that is capable of access network selection, traffic steering and/or traffic aggregation through a network node in a first network operating according to a first radio access technology, RAT, and a network node operating according to a second RAT, the terminal device being adapted to:

on or following disconnection of the terminal device from a first network node operating according to the second RAT that was used for traffic steering or traffic aggregation, perform a procedure to prevent the loss of data packets sent to the first network node by the terminal device or a network node in the first network prior to the disconnection.

47. A terminal device as defined in statement 46, wherein the disconnection of the terminal device is due to any one or more of the following reasons:

(i) selection of a second network node operating according to the second RAT by the terminal device to use as the access network, or for traffic steering and/or traffic aggregation;

(ii) the removal of an identifier for the first network node from a set of identifiers of network nodes operating according to the second RAT that can be used for access network selection, traffic steering and/or traffic aggregation; and/or

(iii) receipt of a signal from the first network, the first network node or another network node operating according to the second RAT indicating that the terminal device is to disconnect from the first network node and/or connect to a different network node operating according to the second RAT.

48. A terminal device as defined in statement 46 or 47, wherein the procedure to prevent the loss of data packets comprises retransmission of packet data convergence protocol, PDCP, packet data units, PDUs, transmission of a PDCP status report, a PDCP, data recovery procedure or a PDCP reestablishment procedure.
49. A terminal device as defined in statement 48, wherein the terminal device is further adapted to receive a signal indicating which of the procedure for retransmissions of PDCP PDUs, transmission of PDCP status report, PDCP data recovery procedure or PDCP reestablishment procedure is to be performed by the terminal device in the event that a procedure to prevent the loss of data packets is to be performed.
50. A terminal device that is capable of access network selection, traffic steering and/or traffic aggregation through a network node in a first network operating according to a first radio access technology, RAT, and a network node operating according to a second RAT, the terminal device comprising a processor and a memory, said memory containing instructions executable by said processor whereby said terminal device is operative to perform operations according to any one of statements 1-13 or 41-44.
51. A network node for use in a first network operating according to a first radio access technology, RAT, wherein a terminal device in the first network is connected to the first network and a first network node operating according to a second RAT, the terminal device using the first network node for traffic steering or traffic aggregation, the network node comprising a processor and a memory, said memory containing instructions executable by said processor whereby said network node is operative to perform operations according to any one of statements 28-33.

1. A method of operating a terminal device, the terminal device being capable of at least one of access network selection, traffic steering and traffic aggregation through a network node in a first network operating according to a first radio access technology, RAT, and a network node operating according to a second RAT, the method comprising:
storing a set of identifiers of network nodes operating according to the second RAT that can be used for at least one of access network selection, traffic steering and traffic aggregation;
receiving an update signal, the update signal indicating at least one identifier of network nodes operating according to the second RAT that are to be at least one of added to and removed from the stored set of identifiers;
updating the stored set of identifiers based on the update signal;
performing an action using the updated set of identifiers; and
when the stored set of identifiers comprises at least two identifiers and the update signal indicates at least one identifier of network nodes operating according to the second RAT that are to be removed from the stored set of identifiers such that the updated set of identifiers comprises at least one identifier of network nodes operating according to the second RAT, the action comprises one of attempting to connect to and maintaining a connection to a network node operating according to the second RAT having an identifier in the updated set of identifiers.

2. The method of claim 1, wherein, in the event that the terminal device is connected to a first network node operating according to the second RAT having an identifier in the stored set that is removed based on the update signal and is not n the updated set of identifiers, the action comprises disconnecting from the first network node and attempting to connect to a network node operating according to the second RAT having an identifier in the updated set of identifiers.

3. The method of claim wherein in the event that the attempt to connect to a network node operating according to the second RAT having an identifier in the updated set of identifiers is unsuccessful, the method further comprises:
sending a failure indication to the first network.

4. The method of claim 1, wherein, in the event that the terminal device is connected to a first network node operating according to the second RAT having an identifier in the stored set of identifiers and in the updated set of identifiers, the action comprises one of maintaining the connection to the first network node and determining a network node operating according to the second RAT to connect to from the network nodes operating according to the second RAT having an identifier in the updated set of identifiers.

5. The method of claim 2, wherein, in the event that the terminal device was using the first network node for at least one of traffic steering and traffic aggregation, the method further comprises:
receiving a signal from the first network indicating that the at least one of traffic steering and traffic aggregation is to be one of suspended and stopped.

6. The method of claim 2, wherein the method further comprises:
performing a procedure to prevent loss of data packets due to the disconnection from the first network node.

7-19. (canceled)

20. A method of operating a network node in a first network operating according to a first radio access technology, RAT, a terminal device in the first network being connected to the first network and a first network node operating according to a second RAT, the terminal device using the first network node for one of traffic steering and traffic aggregation, the method comprising:
receiving an indication that the terminal device was connected to a first network node operating according to the second RAT that has been removed from a set of identifiers of network nodes operating according to the second RAT that the terminal device was using for one of access network selection, traffic steering and traffic aggregation; and
suspending the one of traffic steering and traffic aggregation for the terminal device.

21-32. (canceled)

33. A method of operating a terminal device, the terminal device being capable of at least one of access network selection, traffic steering and traffic aggregation through a network node in a first network operating according to a first radio access technology, RAT, and a network node operating according to a second RAT, the method comprising:
one of on and following disconnection of the terminal device from a first network node operating according to the second RAT that was used for one of traffic steering and traffic aggregation, performing a procedure to prevent the loss of data packets sent to the first network node by one of the terminal device and a network node in the first network prior to the disconnection.

34. The method of claim 33, wherein the disconnection of the terminal device is due to at least one of:
(i) selection of a second network node operating according to the second RAT by the terminal device one of to use as the access network and for at least one of traffic steering and traffic aggregation;
(ii) the removal of an identifier for the first network node from a set of identifiers of network nodes operating according to the second RAT that can be used for at least one of access network selection, traffic steering and traffic aggregation; and
(iii) receipt of a signal from the first network, one of the first network node and another network node operating according to the second RAT indicating that the terminal device is to at least one of disconnect from the first network node and connect to a different network node operating according to the second RAT.

35-41. (canceled)

42. A terminal device that is capable of at least one of access network selection, traffic steering and traffic aggregation through a network node in a first network operating according to a first radio access technology, RAT, and a network node operating according to a second RAT, the terminal device comprising a processor and a memory, the memory containing instructions executable by the processor to configure the terminal device to:
store a set of identifiers of network nodes operating according to the second RAT that can be used for at least one of access network selection, traffic steering and traffic aggregation;
receive an update signal, the update signal indicating at least one identifier of network nodes operating according to the second RAT that are to be at least one of added to and removed from the stored set of identifiers;
update the stored set of identifiers based on the update signal;
perform an action using the updated set of identifiers; and
when the stored set of identifiers comprises at least two identifiers and the update signal indicates at least one identifier of network nodes operating according to the second RAT that are to be removed from the stored set of identifiers such that the updated set of identifiers comprises at least one identifier of network nodes operating according to the second RAT, the action comprises one of attempting to connect to and maintaining a connection to a network node operating according to the second RAT having an identifier in the updated set of identifiers.

43. The terminal device of claim 42, wherein, in the event that the terminal device is connected to a first network node operating according to the second RAT having an identifier in the stored set that is removed based on the update signal and is not in the updated set of identifiers, the action comprises disconnecting from the first network node and attempting to connect to a network node operating according to the second RAT having an identifier in the updated set of identifiers.

44. The terminal device of claim 43, wherein the memory contains instructions executable by the processor to further configure the terminal device to send a failure indication to the first network in the event that the attempt to connect to a network node operating according to the second RAT having an identifier in the updated set of identifiers is unsuccessful.

45. The terminal device of claim 42, wherein, in the event that the terminal device is connected to a first network node operating according to the second RAT having an identifier in the stored set of identifiers and in the updated set of identifiers, the action comprises one of maintaining the connection to the first network node and, determining a network node operating according to the second RAT to connect to from the network nodes operating according to the second RAT having an identifier in the updated set of identifiers.

46. The terminal device of claim 43, wherein the memory contains instructions executable by the processor to further configure the terminal device to receive a signal from the first network indicating that at least one of traffic steering and traffic aggregation to the first network node is to be one of suspended and stopped.

47. The terminal device of claim 43, wherein the memory contains instructions executable by the processor to further configure the terminal device to perform a procedure to prevent loss of data packets due to the disconnection from the first network node.

48. The terminal device of claim 47, wherein the procedure comprises one of retransmission of packet data convergence protocol, PDCP, packet data units, PDUs, transmission of PDCP status report, PDCP data recovery procedure and a PDCP reestablishment procedure.

49. The terminal device of claim 48, wherein the memory contains instructions executable by the processor to further configure the terminal device to receive a signal indicating which of the procedure for one of retransmission of PDCP PDUs, transmission of PDCP status report, PDCP data recovery procedure and PDCP reestablishment procedure is to be performed by the terminal device.

50. The terminal device of claim 42, wherein the memory contains instructions executable by the processor to further configure the terminal device to send a signal to the first network indicating whether the terminal device was connected to a network node operating according to the second RAT having an identifier that was removed from the stored set of identifiers.

51. A network node for use in a first network operating according to a first radio access technology, RAT, wherein a terminal device in the first network is connected to the first network and a first network node operating according to a second RAT, the terminal device using the first network node for traffic steering or traffic aggregation, the network node comprising a processor and a memory, said memory containing instructions executable by the processor to configure the network node to:
receive an indication that the terminal device was connected to a first network node operating according to the second RAT that has been removed from a set of identifiers of network nodes operating according to the second RAT that the terminal device was using for at least one of access network selection, traffic steering and traffic aggregation; and
suspend the one of traffic steering and traffic aggregation for the terminal device.

52. The network node of claim 51, wherein the memory contains instructions executable by the processor to further configure the network node to suspend the one of traffic steering and traffic aggregation by suspending the transmission of terminal device data to the first network node.

53. The network claim 51, wherein the memory contains instructions executable by the processor to further configure the network node to:
determine that the terminal device has connected to a second network node operating according to the second RAT; and
resume one of traffic steering and traffic aggregation for the terminal device via the second network node.

54. The network node of claim 53, wherein the memory contains instructions executable by the processor to further configure the network node to determine that the terminal device has connected to a second network node by determining that a predetermined time period has elapsed since the indication was received from the terminal device.

55. The network node of claim 53, wherein the memory contains instructions executable by the processor to further configure the network node to determine that the terminal device has connected to a second network node by receiving an indication from a flow control mechanism that data for the terminal device is to be sent to the second network node.

56. The network node of claim 53, wherein the memory contains instructions executable by the processor to further configure the network node to determine that the terminal device has connected to a second network node by receiving an indication from the terminal device that the terminal device has connected to a second network node.

57. A terminal device that is capable of at least one of access network selection, traffic steering and traffic aggregation through a network node in a first network operating according to a first radio access technology, RAT, and a network node operating according to a second RAT, the terminal device comprising a processor and a memory, said memory containing instructions executable by the processor to configure the terminal device to:
one of on and following disconnection of the terminal device from a first network node operating according to the second RAT that was used for one of traffic steering and traffic aggregation, perform a procedure to prevent the loss of data packets sent to the first network node by the one of terminal device and a network node in the first network prior to the disconnection.

58. The terminal device of claim 57, wherein the disconnection of the terminal device is due to at least one of:
(i) selection of a second network node operating according to the second RAT by the terminal device one of to use as the access network and for one of traffic steering and traffic aggregation;
(ii) the removal of an identifier for the first network node from a set of identifiers of network nodes operating according to the second RAT that can be used for at least one of access network selection, traffic steering and traffic aggregation; and
(iii) receipt of a signal from the first network, one of the first network node and another network node operating according to the second RAT indicating that the terminal device is to at least one of disconnect from the first network node and connect to a different network node operating according to the second RAT.

59. The terminal device of claim 57, wherein the procedure to prevent the loss of data packets comprises one of retransmission of packet data convergence protocol, PDCP, packet data units, PDUs, transmission of a PDCP status report, a PDCP, data recovery procedure and a PDCP reestablishment procedure.

60. The terminal device of claim 59, wherein the memory contains instructions executable by the processor to further configure the terminal device to receive a signal indicating which of the procedure for one of retransmissions of PDCP transmission of PDCP status report, PDCP data recovery procedure and PDCP reestablishment procedure is to be performed by the terminal device in the event that a procedure to prevent the loss of data packets is to be performed.

61-63. (canceled)
